(19) United States
(12) Patent Application Publication
(10) Pub. No.: US 2023/0146496 A1
(43) Pub. Date: May 11, 2023

(54) MOBILE TOILET

(71) Applicant: LIXIL Corporation, Tokyo (JP)

(72) Inventors: Tatsuyuki TAKEUCHI, Koto-ku, Tokyo (JP); Katsuhisa FUKUMOTO, Koto-ku, Tokyo (JP); Hiroaki WATANABE, Koto-ku, Tokyo (JP); Michitarou MAKI, Koto-ku, Tokyo (JP); Yasuhiro SHIRAI, Koto-ku, Tokyo (JP)

(73) Assignee: LIXIL Corporation, Tokyo (JP)

(21) Appl. No.: 17/918,472

(22) PCT Filed: Apr. 14, 2021
(86) PCT No.: PCT/JP2021/015477

§ 371 Date: Oct. 12, 2022

(30) Foreign Application Priority Data
Apr. 16, 2020 (JP) 2020-073288

(51) Int. Cl. E03D 7/00; B60R 15/04

(52) U.S. Cl. CPC E03D 7/00; B60R 15/04

(57) ABSTRACT

Provided is a mobile toilet that can be used well.

A mobile toilet includes a trailer, a toilet bowl disposed in a cargo box of the trailer, a drain tank disposed in the cargo box and storing sewage discharged from the toilet bowl, a drain passage communicating between the toilet bowl and the drain tank, and a second conveyance device provided in the middle of the drain passage. The toilet bowl has a drain trap communicating with an upstream end of the drain passage, and the drain passage passes a position higher than a sealing water level of the drain trap, and has a spout space provided in a position higher than the sealing water level of the drain trap.

### CROSS-REFERENCE TO RELATED APPLICATIONS

This application is a national stage application under 35 U.S.C. 371 of International Application No. PCT/JP2021/015477, filed Apr. 14, 2021, which claims the priority of Japanese Application No. 2020-073288, filed Apr. 16, 2020, the entire contents of each priority application of which are incorporated herein by reference.

### FIELD OF THE DISCLOSURE

The present disclosure relates to a mobile toilet.

### BACKGROUND OF THE DISCLOSURE

JP H11-208359 A discloses a conventional mobile toilet. This mobile toilet includes a machine room, a septic tank, and a toilet room unit in a cargo box of a trailer. The toilet room unit includes a plurality of toilet bowls therein. This mobile toilet includes a sewage pump unit below the toilet room unit. The sewage pump unit temporarily stores sewage flowing in from each toilet bowl. The sewage pump unit pumps the temporarily stored sewage to the septic tank.

### SUMMARY OF THE DISCLOSURE

In a conventional mobile toilet, sewage flows down from each toilet bowl to the sewage pump unit disposed below the toilet bowls. In a case where each toilet bowl has a drain trap, there is a possibility that sealing water is drained from the drain trap. When sealing water is drained from the drain trap of the toilet bowl, odor flows back from the sewage pump unit to the toilet room unit.

The present disclosure has been made in view of the above conventional circumstances, and an object of the present disclosure is to provide a mobile toilet that can be used well.

A mobile toilet according to the present disclosure includes: a vehicle; a sanitary fixture disposed in the vehicle; a drain tank that is disposed in the vehicle and stores sewage discharged from the sanitary fixture; a drain passage that communicates between the sanitary fixture and the drain tank; and a conveyance device provided in the drain passage. The sanitary fixture has a drain trap communicating with an upstream end of the drain passage, and the drain passage passes a position higher than a water level of the drain trap in a water-sealed state, and has a separation portion provided in a position higher than the water level of the drain trap in a water-sealed state.

### BRIEF DESCRIPTION OF THE FIGURES

FIG. 1 is a vertical sectional view of a mobile toilet according to a first embodiment as viewed from the left.

FIG. 2 is a plan view of the mobile toilet according to the first embodiment.

FIG. 3 is an enlarged cross-sectional view of a main part according to the first embodiment.

FIG. 4 is an enlarged cross-sectional view of a main part according to the first embodiment.

FIG. 5 is a perspective view of a part of a toilet room according to the first embodiment.

### DETAILED DESCRIPTION OF THE DISCLOSURE

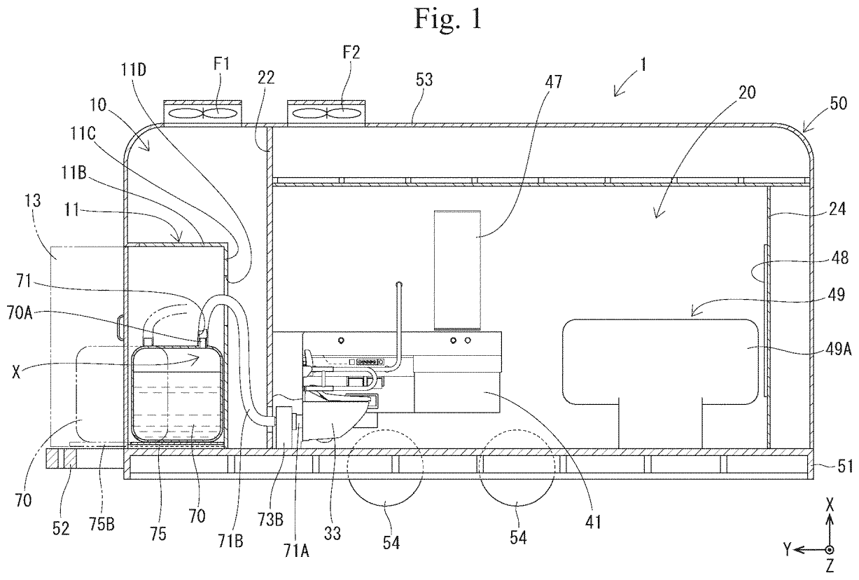

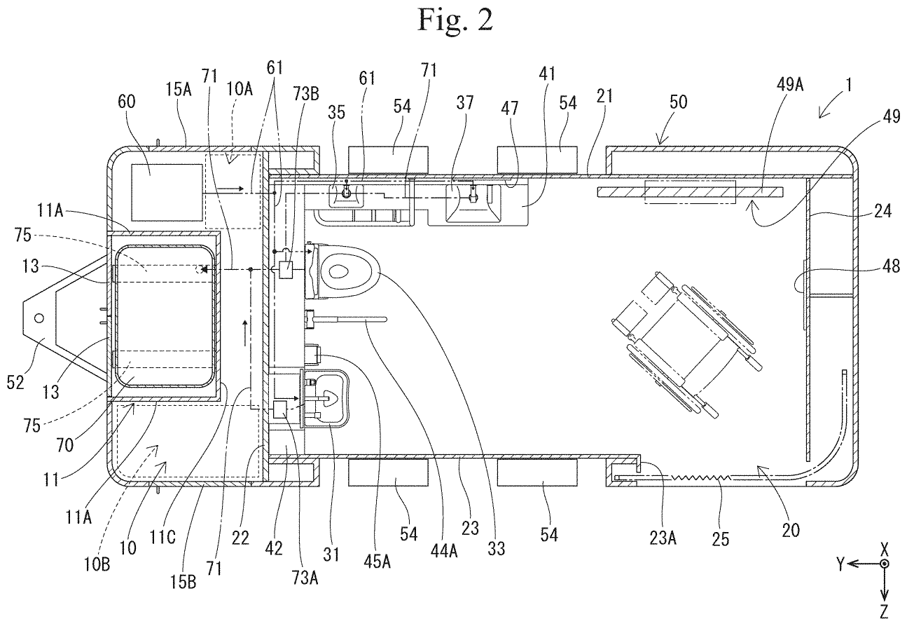

Embodiments of a mobile toilet 1 according to the present disclosure will be described with reference to the drawings. In the following description, as for an up-down direction, a positive direction of the X axis illustrated in FIG. 1 is an upward direction, and a negative direction of the X axis is a downward direction. As for a left-right direction, a positive direction of the Z axis illustrated in FIG. 2 is a left direction, and a negative direction of the Z axis is a right direction. As for a front-rear direction, a positive direction of the Y axis illustrated in FIGS. 1 and 2 is a forward direction, and a negative direction of the Y axis is a rearward direction.

As illustrated in FIGS. 1 to 4, the mobile toilet 1 includes a trailer 50, which is a vehicle. The trailer 50 includes a substantially rectangular parallelepiped cargo box 53 which is attached to a chassis 51 and is elongated in the front-rear direction. The trailer 50 is towed by a tractor (not illustrated) or the like. The chassis 51 extends in the front-rear direction. The chassis 51 includes a joining unit 52 at a front end thereof. The joining unit 52 can be joined to the tractor. Two wheels 54 are rotatably attached to a central portion of the chassis 51 in the front-rear direction on each of the left and right sides. The trailer 50 is movable in the front-rear direction.

The trailer 50 is provided with an equipment room 10 and a toilet room 20 in the cargo box 53. The equipment room 10 and the toilet room 20 are provided side by side in the front-rear direction. The mobile toilet 1 includes a ventilation fan F1 that exhausts air in the equipment room 10 and a ventilation fan F2 that exhausts air in the toilet room 20.

The equipment room 10 is disposed at a front portion of the cargo box 53. In each of right and left walls of the equipment room 10, an opening that allows a person to go in or out of the equipment room 10 is formed. The right wall is provided with a right door 15A which opens and closes the opening of the right wall, and the left wall is provided with a left door 15B which opens and closes the opening of the left wall (see FIG. 2).

The right door 15A is opened for allowing a person to go in or out of a right region 10A in the equipment room 10 through the opening of the right wall. The right region 10A in the equipment room 10 is mainly used as a work space for installation, maintenance, and the like of a toilet bowl 33, which will be described later. The left door 15B is opened for allowing a person to go in or out of a left region 10B in the equipment room 10 through the opening of the left wall. The left region 10B in the equipment room 10 is mainly used as a work space for installation, maintenance, and the like of a slop sink 31, which will be described later.

The toilet room 20 is disposed adjacent to and behind the equipment room 10. The toilet room 20 is surrounded by a first wall 21, a second wall 22, a third wall 23, and a fourth wall 24. The first wall 21 stands on a right side of the toilet room 20. The second wall 22 partitions the toilet room 20 and the equipment room 10, and stands on a front side of the toilet room 20. The third wall 23 stands on a left side of the toilet room 20. The fourth wall 24 stands on a rear side of the toilet room 20. In the toilet room 20, an entrance 23A is formed at a rear portion of the third wall 23 through which a person goes in or out of the toilet room 20. The entrance 23A is provided with a door 25. The door 25 has a bellows shape, and is slid in the front-rear direction to open and close the entrance 23A.

As illustrated in FIGS. 1, 2, and 5, the mobile toilet 1 includes a plurality of types of sanitary fixtures 31, 33, 35, and 37. The sanitary fixtures are the slop sink 31, a toilet bowl 33, a hand wash basin 35, and a wash basin 37. The sanitary fixtures are disposed in the toilet room 20. In addition to the sanitary fixtures 31, 33, 35, and 37, the toilet room 20 includes a first cabinet 41, a second cabinet 42, a backrest 43, handrails 44A and 44B, toilet paper holders 45A and 45B, a mirror cabinet 46, a first mirror 47, a second mirror 48, and a folding bed 49.

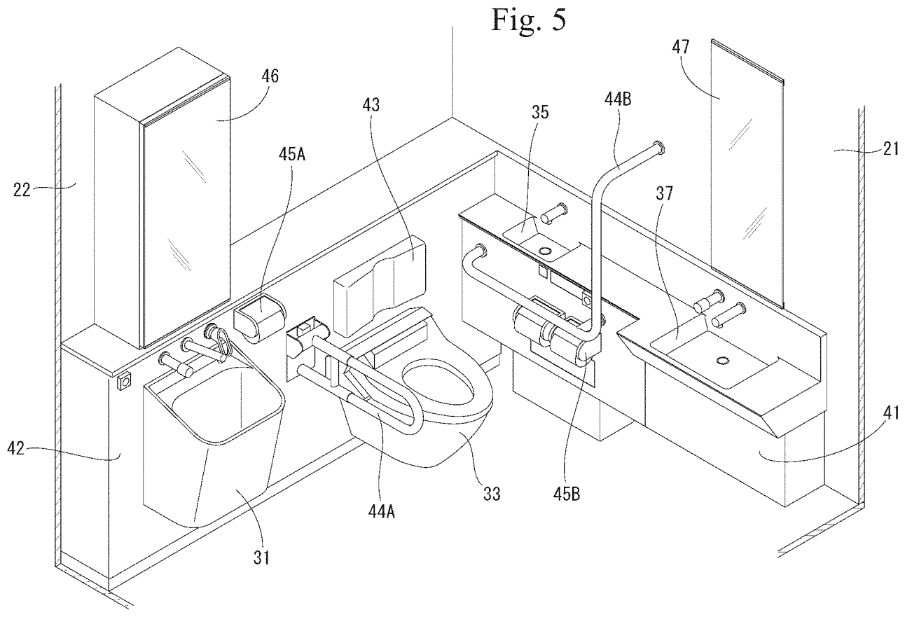

As illustrated in FIG. 5, the first cabinet 41 has a box shape, and is attached such that a rear surface thereof is in contact with the first wall 21. The second cabinet 42 has a box shape slightly larger than the first cabinet 41, and is attached such that a rear surface thereof is in contact with the second wall 22.

The slop sink 31 is attached to a left side of a front surface of the second cabinet 42. The front surface of the second cabinet 42 is a surface facing rearward. The toilet bowl 33 is attached to a right side of the front surface of the second cabinet 42. The backrest 43 is attached to the front surface of the second cabinet 42 and above the toilet bowl 33. The handrail 44A and the toilet paper holder 45A are attached to the front surface of the second cabinet 42 and between the slop sink 31 and the toilet bowl 33. The handrail 44A is of a flip-up type. The mirror cabinet 46 is placed on an upper surface of the second cabinet 42, and is attached such that a rear surface thereof is in contact with the second wall 22. The mirror cabinet 46 is located above the slop sink 31.

The hand wash basin 35 is attached to an upper part of the first cabinet 41 near the toilet bowl 33 (that is, on the front side of the toilet room 20). The toilet paper holder 45B and the handrail 44B are attached to a front surface of the first cabinet 41 and below the hand wash basin 35. The handrail 44B is a fixed type. The front surface of the first cabinet 41 is a surface facing leftward. The wash basin 37 is attached to an upper part of the first cabinet 41 away from the toilet bowl 33 (that is, on a rear side relative to the hand wash basin 35). The first mirror 47 is attached to the first wall 21 above the wash basin 37.

As illustrated in FIGS. 1 and 2, the folding bed 49 is attached to the first wall 21 on a rear side relative to the first cabinet 41. A bed body 49A of the folding bed 49 is disposed along the first wall 21 when the folding bed 49 is not used, and is disposed parallel to a floor surface when the folding bed 49 is used. The state in which the bed body 49A is parallel to the floor surface is not illustrated. The second mirror 48 is attached to the fourth wall 24. A space on the front side of the second mirror 48 in the toilet room 20 is large enough to allow a wheelchair user to change the direction or move when the folding bed is not used.

As illustrated in FIGS. 2 to 4, the mobile toilet 1 includes a water supply device 60, a water supply passage 61, a drain tank 70, a drain passage 71, a first conveyance device 73A, and a second conveyance device 73B. The water supply device 60 and the drain tank 70 are disposed in the equipment room 10. In the equipment room 10, a box 11 is fixed at a central portion in the left-right direction. The box 11 has left and right walls 11A, an upper wall 11B, and a rear wall 11C which are formed of flat plates, and a front side thereof is open. The rear wall 11C of the box 11 has an opening 11D through which a hose 71B, which will be described later, is inserted. A lower end edge of the opening 11D is located higher than an upper surface of the toilet bowl 33 and an upper surface of the slop sink 31. The equipment room 10 has a door 13 that opens and closes the front-side opening of the box 11.

The water supply device 60 includes a water supply tank (not illustrated) and a water supply pump (not illustrated). The water supply tank stores clean water to be supplied to each of the sanitary fixtures 31, 33, 35, and 37 provided in the toilet room 20. The water supply tank and the sanitary fixtures 31, 33, 35, and 37 communicate with each other through the water supply passage 61. In the water supply device 60, when the water supply pump is driven, the clean water stored in the water supply tank flows into the sanitary fixtures 31, 33, 35, and 37 through the water supply passage 61.

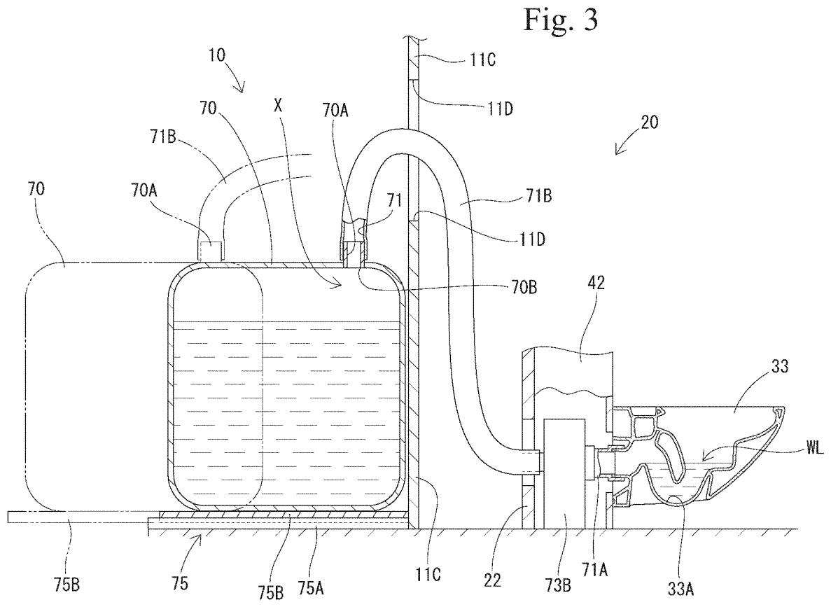

The drain tank 70 is housed in the box 11 and is disposed at a central portion of the equipment room 10 in the left-right direction. The drain tank 70 has a rectangular parallelepiped shape, and a tubular connection port 70A is formed on an upper surface thereof. The connection port 70A is inserted into and connected to a downstream end of the hose 71B, which will be described later. The drain tank 70 has an opening (not illustrated) formed in the upper surface thereof, and has a lid member that opens and closes the opening. Sewage can be discharged from the drain tank 70 through the opening by removing the lid member. As illustrated in FIGS. 1 and 3, a height of the drain tank 70 is higher than the upper surface of the toilet bowl 33 and slightly lower than a height of the second cabinet 42.

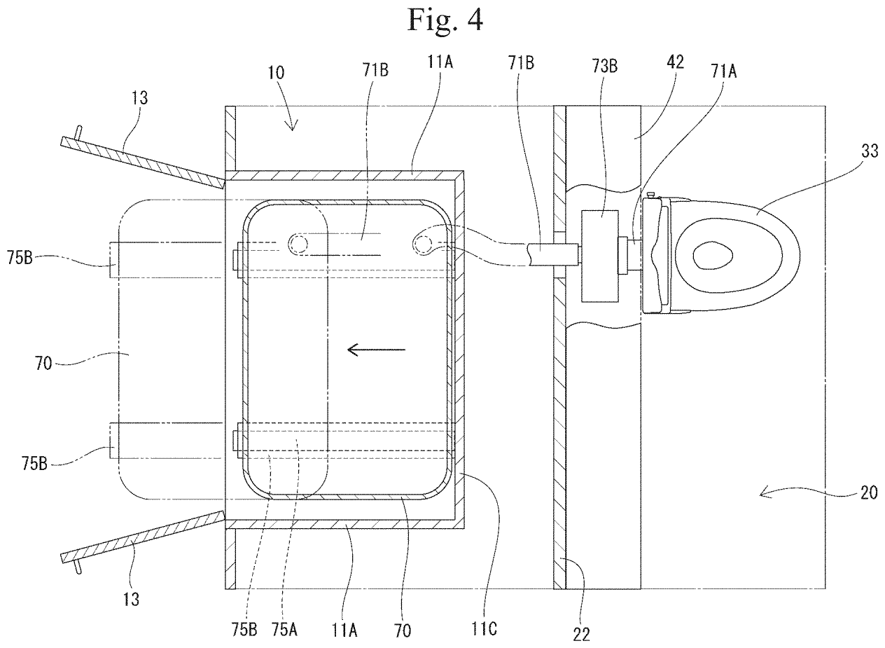

As illustrated in FIGS. 3 and 4, the drain tank 70 is moved back and forth between a storage position where the drain tank 70 is stored in the box 11 and a drawn-out position where the drain tank 70 is drawn out of the cargo box 53 (outside the storage position) in front of the box 11 by using a pair of slide rails 75. Specifically, the slide rails 75 are arranged apart from each other in the left-right direction and extend linearly in the front-rear direction, and a fixed rail 75A of each of the slide rails 75 is fixed to a floor surface of the equipment room 10, and a movable rail 75B is fixed to a bottom surface of the drain tank 70. Each of the slide rails 75 has a lock mechanism (not illustrated) that locks the movable rail 75B into a state of being pushed in the fixed rail 75A. By bringing the lock mechanism of each slide rail 75 into a locked state, the drain tank 70 is fixed at the storage position. By bringing the lock mechanism of each slide rail 75 into an unlocked state, the drain tank 70 can be drawn out forward from the storage position to the drawn-out position. At the drawn-out position, half or more of the drain tank 70 in the front-rear direction is drawn out of the cargo box 53.

As illustrated in FIG. 2, the drain tank 70 and the sanitary fixtures 31, 33, 35, and 37 communicate with each other through the drain passage 71. Specifically, each of the sanitary fixtures 31, 33, 35, and 37 has a drain trap 33A, and an upstream end of the drain passage 71 communicates with a drain port of each drain trap 33A (see FIG. 3).

The first conveyance device 73A is provided in the middle of the drain passage 71 communicating with the slop sink 31. An inflow port of the first conveyance device 73A is connected to a downstream end of a connection pipe connected to an outlet port of the drain trap of the slop sink 31 (not illustrated). This connection pipe forms the drain passage 71 on an upstream side relative to the first conveyance device 73A. A drain port of the first conveyance device 73A is connected to an upstream end of a hose having flexibility (not illustrated). This hose forms the drain passage 71 on a downstream side relative to the first conveyance device 73A. The first conveyance device 73A is housed in the second cabinet 42. The hose connected to the drain port of the first conveyance device 73A extends from the second cabinet 42 into the equipment room 10. A portion of this hose that is inserted through the second wall 22 is fixed to the second wall 22. A downstream end of the hose is connected to an intermediate portion of a hose 71B connected to a drain port of the second conveyance device 73B, which will be described later.

As illustrated in FIG. 3, the second conveyance device 73B is provided in the middle of the drain passage 71 communicating with the toilet bowl 33. An inflow port of the second conveyance device 73B is connected to a downstream end of a connection pipe 71A connected to an outlet port of the drain trap 33A of the toilet bowl 33. This connection pipe 71A forms the drain passage 71 on an upstream side relative to the second conveyance device 73B. A drain port of the second conveyance device 73B is connected to an upstream end of the hose 71B having flexibility. A downstream end of the hose 71B is detachably connected to the connection port 70A of the drain tank 70. This hose 71B forms the drain passage 71 on a downstream side relative to the second conveyance device 73B. The second conveyance device 73B is housed in the second cabinet 42. The hose 71B connected to the drain port of the second conveyance device 73B extends from the second cabinet 42 into the equipment room 10. A portion of this hose 71B that is inserted through the second wall 22 is fixed to the second wall 22.

The drain passages 71 communicating with the hand wash basin 35 and the wash basin 37 merge on an upstream side relative to the second conveyance device 73B, and the second conveyance device 73B is provided in the middle of the drain passage 71 on a downstream side relative to the merging portion. An inflow port of the second conveyance device 73B is connected to a downstream end of a connection pipe connected to the hand wash basin 35 and the wash basin 37. This connection pipe forms the drain passage 71 on an upstream side relative to the second conveyance device 73B.

As illustrated in FIG. 3, the hose 71B connected to the drain port of the second conveyance device 73B is inserted into the opening 11D of the rear wall 11C of the box 11 fixed to the equipment room 10, and has a downstream end connected to the connection port 70A formed on the upper surface of the drain tank 70. As described above, the hose 71B connected to the drain port of the second conveyance device 73B extends upward to a position higher than a water level of the drain trap 33A in a water-sealed state of the toilet bowl 33 (hereinafter referred to as a “sealing water level WL”) and higher than the upper surface of the drain tank 70.

The hose 71B connected to the drain port of the second conveyance device 73B has a length that allows the drain tank 70 to be drawn out to the drawn-out position in a state where the downstream end thereof is connected to the connection port 70A of the drain tank 70. Specifically, the hose 71B has such a length that the hose 71B is inserted into the opening 11D formed in the rear wall 11C of the box 11 while being sufficiently away upwardly from the lower end edge of the opening 11D when the drain tank 70 is disposed at the storage position, and that the hose 71B is inserted into the opening 11D while being away upwardly from the lower end edge of the opening 11D even when the drain tank 70 is moved to the moved position. That is, an entire length of the hose 71B is a dimension that does not hinder movement of the drain tank 70 between the storage position and the drawn-out position. When the drain tank 70 is moved between the storage position and the drawn-out position, the hose 71B always passes a position higher than the sealing water level WL. Similarly, the hose 71B passes a position higher than the sealing water level WL of the other sanitary fixtures 31, 35, and 37.

The drain tank 70 is provided with a water level sensor (not illustrated). The water level sensor of the drain tank 70 detects a maximum water level of sewage that can be stored in the drain tank 70. The maximum water level of sewage in the drain tank 70 is a height that is away downwardly by a predetermined distance from a downstream end opening 70B of the connection port 70A of the drain tank 70.

In the mobile toilet 1, when the water level sensor detects that sewage in the drain tank 70 has reached the maximum water level, the water level sensor outputs a full water detection signal to a control unit. Upon receipt of the full water detection signal, the control unit outputs a notification signal to a notification unit (not illustrated), and outputs a drive stop signal to the water supply device 60, the first conveyance device 73A, and the second conveyance device 73B. Upon receipt of the notification signal, the notification unit notifies that the sanitary fixtures 31, 33, 35, and 37 are unusable. Upon receipt of the drive stop signal, the water supply device 60, the first conveyance device 73A, and the second conveyance device 73B become unable to be driven.

By the notification by the notification unit, a user of the mobile toilet 1 can recognize that the sanitary fixtures are unusable, and a person who manages the mobile toilet 1 performs maintenance such as draining sewage stored in the drain tank 70. As described above, a water level of the sewage in the drain tank 70 does not exceed the maximum water level, and a water surface of the sewage and the downstream end opening 70B of the connection port 70A of the drain tank 70 are always separated by a predetermined distance or more. A spout space X is formed between the water surface of the sewage in the drain tank 70 and the downstream end opening 70B of the connection port 70A of the drain tank 70 so that the water surface of the sewage in the drain tank 70 and the downstream end opening 70B of the connection port 70A of the drain tank 70 are always separated by the predetermined distance or more, thus forming a separation portion for preventing backflow of the drain passage 71. This separation portion is provided at a position higher than the sealing water level WL of each of the sanitary fixtures 31, 33, 35, and 37.

The sanitary fixtures 31, 33, 35, and 37 of the mobile toilet 1 are used as follows. In the case of washing the toilet bowl 33, an operation unit is operated to open an opening/closing valve provided in the toilet bowl 33. In response to the operation of the operation unit, a water ejection signal output from the operation unit is input to the control unit, and operation of the water supply pump is started by the control unit. When the water supply pump is operated, clean water flows from the water supply tank into the toilet bowl 33 through the water supply passage 61. The clean water flowing into the toilet bowl 33 washes the toilet bowl 33 and thereafter flows into the second conveyance device 73B as sewage. When the sewage flowing into the second conveyance device 73B reaches a predetermined amount, the control unit drives a pump function, and the sewage flows into the drain tank 70 through the drain passage 71 and is stored in the drain tank 70. When sewage inside the second conveyance device 73B is discharged, the control unit stops the pump function of the second conveyance device 73B. When a predetermined time elapses after the operation of the operation unit, the opening/closing valve of the toilet bowl 33 is closed, and the operation of the water supply pump is stopped by the control unit. In this way, washing of the toilet bowl 33 ends. When washing the slop sink 31, the water supply pump and the first conveyance device 73A are driven in a similar manner to perform washing.

In the case of ejecting clean water from a water ejection portion provided in the slop sink 31, when an operation handle provided in the slop sink 31 is operated to open an opening/closing valve, the water supply pump is operated by the control unit, and when the operation handle is operated to close the opening/closing valve, the water supply pump is stopped by the control unit. In this way, clean water can be ejected from the water ejection portion of the slop sink 31. Sewage flowing into the first conveyance device 73A from the slop sink 31 flows, by the first conveyance device 73A, into the drain tank 70 through the drain passage 71 and is stored in the drain tank 70. When the sewage flowing into the first conveyance device 73A reaches a predetermined amount, the control unit drives a pump function, and when the sewage inside the first conveyance device 73A is discharged, the control unit stops the pump function of the first conveyance device 73A.

In the case of ejecting clean water from a water ejection portion provided in the hand wash basin 35 and the wash basin 37, an opening/closing valve provided in the hand wash basin 35 and the wash basin 37 is opened while a sensor is detecting a user's hand or the like, and the opening/closing valve provided in the hand wash basin 35 and the wash basin 37 is closed when the sensor no longer detects the user's hand or the like. While the sensor is detecting a user's hand or the like, a water ejection signal is continuously input from the operation unit to the control unit, and the operation of the water supply pump is continued by the control unit. In this way, clean water can be ejected from the water ejection portion provided in the hand wash basin 35 and the wash basin 37. Sewage flowing into the second conveyance device 73B from the hand wash basin 35 and the wash basin 37 flows, by the second conveyance device 73B, into the drain tank 70 through the drain passage 71 and is stored in the drain tank 70. When the sewage flowing into the second conveyance device 73B reaches a predetermined amount, the control unit drives a pump function, and when the sewage inside the second conveyance device 73B is discharged, the control unit stops the pump function of the second conveyance device 73B.

As described above, the mobile toilet 1 includes the trailer 50, the sanitary fixtures 31, 33, 35, and 37, the drain tank 70, the connection pipe 71A and the hose 71B having flexibility, which are the drain passage 71, the first conveyance device 73A, and the second conveyance device 73B. The trailer 50 is movable in the front-rear direction. Each of the sanitary fixtures 31, 33, 35, and 37 is disposed in the cargo box 53 of the trailer 50. The drain tank 70 is disposed in the cargo box 53 of the trailer 50 and stores sewage discharged from each of the sanitary fixtures 31, 33, 35, and 37. The drain passage 71 communicates between each of sanitary fixtures 31, 33, 35, and 37 and the drain tank 70. The first conveyance device 73A and the second conveyance device 73B are provided in the middle of the drain passage 71. Each of the sanitary fixtures 31, 33, 35, and 37 has the drain trap 33A connected to an upstream end of the connection pipe 71A. The hose 71B having flexibility passes a position higher than the sealing water level WL of each of the sanitary fixtures 31, 33, 35, and 37, and has the spout space X provided in a position higher than the sealing water level WL.

In the mobile toilet 1, the hose 71B forming the drain passage 71 which communicates between each of the sanitary fixtures 31, 33, 35, and 37 and the drain tank 70 passes a position higher than the sealing water level WL of each of the sanitary fixtures 31, 33, 35, and 37, and has the spout space X provided in a position higher than the sealing water level WL. Therefore, the mobile toilet 1 can prevent sealing water from being drained from the drain trap 33A of each of the sanitary fixtures 31, 33, 35, and 37, and can prevent odor from flowing back from the first conveyance device 73A and the second conveyance device 73B into the cargo box 53 of the trailer 50 in which each of the sanitary fixtures 31, 33, 35, and 37 is disposed.

Therefore, this mobile toilet 1 can be used well.

In the mobile toilet 1, a half or more of the drain tank 70 in the front-rear direction can be drawn out to the outside of the cargo box 53 (the outside of the storage position (drawn-out position)). Therefore, in the mobile toilet 1, maintenance such as discharge of sewage from the drain tank 70 and cleaning of the drain tank 70 can be easily performed outside the cargo box 53.

The drain passage 71 on the downstream side relative to the first conveyance device 73A and the second conveyance device 73B is formed of the hose 71B having flexibility. The entire length dimension of the hose 71B is a dimension that does not hinder movement of the drain tank 70 between the storage position and the drawn-out position. The mobile toilet 1 is thus configured such that the drain tank 70 can be easily moved between the storage position and the drawn-out position while the hose 71B is connected to the drain tank 70. After the drain tank 70 is moved to the drawn-out position while keeping the connection of the hose 71B, the hose 71B can be removed from the connection port 70A of the drain tank 70, and then the drain tank 70 can be completely carried out of the cargo box 53. By completely carrying out the drain tank 70 to the outside of the cargo box 53, maintenance such as cleaning of the drain tank 70 can be more easily performed.

The present disclosure is not limited to the embodiments described by the above description and drawings, and for example, the following embodiments are also encompassed within the technical scope.

(1) In some embodiments, the mobile toilet is configured such that the sanitary fixtures are disposed in the trailer. Not limited to this, the mobile toilet may be configured such that the sanitary fixture is disposed in a luggage room of an automobile.
(2) In some embodiments, a plurality of types of sanitary fixtures are provided, and one sanitary fixture is provided for each type. Not limited to this, one or more sanitary fixtures may be provided for each type, and one or more types of sanitary fixtures may be provided.
(3) In some embodiments, a water surface of sewage and a downstream end opening of a connection port of a hose of a drain tank are always separated by a predetermined distance or more to form a spout space, and thereby a separation portion for preventing backflow of a drain passage is formed. Not limited to this, the mobile toilet may be configured such that a backflow prevention device such as a vacuum breaker valve is provided in the middle of the drain passage to form the separation portion.
(4) In some embodiments, the drain tank can be moved between the storage position and the drawn-out position. Not limited to this, the drain tank may be fixed in the box provided in the cargo box.
(5) In some embodiments, the box is fixed in the cargo box. Not limited to this, the box may not be provided and the drain tank may be fixed at a predetermined position in the cargo box.
(6) In some embodiments, the hose that forms the drain passage is inserted into the opening formed in the rear wall of the box while being away upwardly from the lower end edge of the opening so that the movement of the drain tank between the storage position and the drawn-out position is not hindered. Not limited to this, the hose may be wound above the drain tank when the drain tank is disposed at the storage position, and the hose above the drain tank may be extended when the drain tank is moved to the drawn-out position.

1. A mobile toilet comprising:
a vehicle;
a sanitary fixture disposed in the vehicle;
a drain tank disposed in the vehicle, the drain tank storing sewage discharged from the sanitary fixture;
a drain passage communicating between the sanitary fixture and the drain tank; and
a conveyance device provided in a middle of the drain passage, wherein
the sanitary fixture has a drain trap communicating with an upstream end of the drain passage, and
the drain passage passes a position higher than a sealing water level, the sealing water level being a water level of the drain trap in a water-sealed state, and has a separation portion provided in a position higher than the water level of the drain trap in a water-sealed state.

2. The mobile toilet of claim 1, wherein
at least a part of the drain tank is configured to be drawn out from a storage position where the drain tank is disposed in the vehicle to a drawn-out position where the drain tank is an outside of the storage position.

3. The mobile toilet of claim 2, wherein the drain passage is formed of a hose,
the hose having flexibility, and
an entire length dimension of the hose being a dimension that does not hinder movement of the drain tank between the storage position and a drawn-out position where the drain tank has been drawn out to an outside of the storage position.

4. The mobile toilet of claim 1, wherein the drain passage extends upward to a position, the position being higher than the sealing water level and higher than an upper surface of the drain tank, and is connected to the separation portion from the upper surface of the drain tank.

5. The mobile toilet of claim 1, wherein the separation portion is a spout space between a water surface of the sewage in the drain tank and a downstream end opening of a connection port of the drain tank.

6. The mobile toilet of claim 1, wherein the drain passage is connected to the sanitary fixture at a position higher than the sealing water level.

7. The mobile toilet of claim 1, wherein the drain passage always passes a position higher than the sealing water level.

8. The mobile toilet of claim 1, wherein the drain passage passes through a wall having an opening and is connected to the drain tank by being inserted into the opening, and the drain passage is inserted into the opening while being away upwardly from a lower end edge of the opening.

9. The mobile toilet of claim 1, wherein the drain passage passes through a wall having an opening and is connected to the drain tank by being inserted into the opening, and at a storage position where the drain tank is disposed inside the vehicle, the drain passage is inserted into the opening while being away downwardly from an upper end edge of the opening.
